(19) United States
(12) Patent Application Publication
(10) Pub. No.: US 2011/0047583 A1
(43) Pub. Date: Feb. 24, 2011

(54) INTEGRATED WIRELESS MOBILEMEDIA SYSTEM

(75) Inventors: Kevin B. Howard, Laguna Niguel, CA (US); Kurtis S. Van Horn, JR., Irvine, CA (US); Gordon J. Davidson, San Diego, CA (US)

Correspondence Address: PAUL, HASTINGS, JANOFSKY & WALKER LLP, 875 15th Street, NW, Washington, DC, 20005, US

(73) Assignee: INTERNET CONNECTIVITY GROUP, INC., Lake Forest, CA (US)

(21) Appl. No.: 12/707,328

(22) Filed: Feb. 17, 2010

Related U.S. Application Data
(63) Continuation-in-part of application No. 12/037,083, filed on Feb. 25, 2008.

(51) Int. Cl. H04N 7/173

(52) U.S. Cl. 725/109; 725/127

(57) ABSTRACT

An integrated wireless MobileMedia system is provided. One embodiment includes a wireless media system for distributing media content, the wireless media system including; a base unit that includes: (1) a WWAN modem for receiving the media content over a WWAN network; (2) a router in communication with the WWAN modem; and (3) a transmitter for wirelessly transmitting the media content to one or more wireless receivers, wherein a first wireless receiver is configured to wirelessly receive the media content from the transmitter and push the media content to a video device. In some embodiments, the wireless media system further includes a TV tuner device for receiving live video content. Another embodiment is a method for distributing media content using a base station with a WWAN modem, a router, a controller, and a transmitter, the method including: receiving, over a WWAN network, the media content at a WWAN modem; transmitting, by way of the router, the media content from the WWAN modem to the controller; coordinating, using the controller, the delivery of the media content to one or more wireless receivers; and transmitting the media content to a first wireless receiver.

This application claims priority as a Continuation-In-Part application under 35 U.S.C. §120 to U.S. patent application Ser. No. 12/037,083, entitled “Integrated Wireless MobileMedia System,” filed Feb. 25, 2008.

### BACKGROUND

I. Field

The presently disclosed embodiments relate generally to wireless communications, and more specifically to an integrated wireless mobile multi-media system.

II. Background

Digital signage is a form of out-of-home advertising in which content and multimedia messages displayed on an electronic screen, or digital sign, can be changed without modification to the physical sign, typically with the goal of delivering targeted messages to specific locations at specific times. Digital signage offers superior return on investment compared to traditional printed signs. The multi-media content displayed on digital signage screens can range from simple text and still images to full-motion video, with or without audio. Some operators of digital signage networks, particularly in the retail industry, regard their networks as comparable to television channels, displaying entertaining and informational content interspersed with advertisement.

Digital signage is used for many different purposes. Digital signage is commonly used to provide travelers with information such as flight information in airports and wait-times for the next train. Digital signage provides retailers with location related advertising and in-store promotions shown to uplift sales in retail establishments. Point of sale advertising and promotions, where the majority of purchase decisions are made, include automatic user coupon distribution and brand specific audio and video advertising.

Digital signage is used as a mechanism for advertising by third parties, or digital advertising companies, that sell advertising space to local merchants, service providers, media resellers and national advertisers. Digital signage applications are employed to enhance customer experience. Examples of customer experience enhancement include digital signage in restaurant waiting areas to reduce perceived wait-time, recipe demonstrations in food stores entertainment while pumping gas and so forth.

Other signage applications include the influencing of customer behavior. Examples of customer behavior influence are post office digital signage that directs patrons waiting in line to automated stamp machines and retail digital signage designed to direct customers to different areas of the store, increasing the time spent on the store premises (dwell time). Digital signage is commonly used for brand building, such as Niketown stores where digital signage in video form is used as a part of the store décor to build a story around the brand. Digital signage is also used for collecting follow through campaign information for store managers and increasing the customer experience with the building itself.

Digital signs may be, for example, scrolling message boards, DLP, LCD, LED, or plasma display panels, electronic billboards, projection screens, or other emerging display types like living surfaces or Organic LED screens (“OLEDs”) that can be controlled electronically using a computer or other devices, allowing individuals or groups to remotely change and control their content (usually via the Internet). Rapidly-dropping prices for large plasma and LCD screens and wide availability of Internet connectivity have caused digital signage deployments to gain in popularity, and displays can now be found in such diverse locations as retail outlets, transit hubs (like airports or bus stations), doctor's offices, fast food restaurants and even gas stations. The recent introduction of free digital signage software will further expand the “pool” of potential users of this technology. It will now be attractive to smaller businesses (that may have otherwise found this technology too expensive), as well as to “non-profits” such as schools, universities and churches, rather than only to large companies that spend billions yearly to present their consumer advertisements.

Multi-media content scheduling and playback can be controlled by a number of technologies ranging from simple, non-networked media players that output basic loops of MPEG-2 video to complex, N-tier player networks that offer control over multiple displays in many venues from a single location. The former is ideal for small groups of displays that can be updated via sneaker net (the practice of physically transporting data to each location on a disc (CD or DVDE) or USB flash drive, usually by walking), while the latter allows Digital Signage Network Operators to either push content to many players at once or have each player pull content from a server as needed.

Traditional digital signage systems are typically television monitors, or displays, distributed throughout high traffic areas or point of sale locations at a business site on a Local Area Network (“LAN”). These networked displays are typically Ethernet coupled to an on site local network server, which transfers advertising content to the displays. The server may be configured to receive advertisement information from the Internet or a hard storage media such as hard disk, floppy disk, optical disk, USB flash drive, etc.

Unfortunately, these traditional systems are immobile and overly costly. Traditional systems normally require wiring for Internet access and networking, hard line connections, and media players and memory storage devices at every display unit. Maintaining a LAN at a business site is often cost prohibitive for small businesses. Not only is the cost of using and maintaining a LAN relatively high, traditional systems can neither be easily moved from their original sites nor reconfigured to accommodate on-site merchandise relocations.

While some advertising systems configured for point of sale use attempt to overcome these shortcomings, they are either only partially wireless, have no wireless Internet connectivity, or fail to deliver wire quality full stream audio and video. Thus, there is a need in the art for a turnkey media solution that overcomes the problems described above.

### SUMMARY

Embodiments disclosed herein address the above-stated needs by providing an integrated wireless MobileMedia system. The system, in some embodiments, receives content from a Wireless Wide Area Network (“WWAN”), such as a wireless broadband or mobile broadband network. In some embodiments, the system can also receive content from a live television feed or locally connected video camera. In some embodiments, the received content is then wirelessly distributed to various locations, such as point of sale locations, via, for example, IEEE 802.11(n), 802.11(ac), 802.11(ad), later communications protocols, and/or other protocols. Audio and high definition video, in some embodiments, are streamed over MIMO RF technology incorporating JPEG2000, later compression algorithms, and/or other compression algorithms that provide transmission quality, in some instances, up to or better than wired connectivity over a wireless link. In some embodiments, the system requires no wired communications infrastructure such that the entire system may travel, or advertising displays are readily relocatable within the retail environment. Media content can be unicast for point to point (single endpoint) or multipoint delivery. The system may also include wireless local hotspot connectivity via, for example, IEEE 802.11(g) and later communications protocols, and/or other protocols.

In one embodiment, a wireless media system for distributing media content is provided. The wireless media system includes a base unit. In some embodiments, the base unit comprises a WWAN modem for receiving the media content over a WWAN network, a router in communication with the WWAN modem, and a transmitter for wirelessly transmitting the media content to one or more wireless receivers. A wireless receiver, in some embodiments, is configured to wirelessly receive the media content from the transmitter and push the media content to an audio/video device. In some embodiments, the modem and router are integrated with the base unit. In one embodiment, the base unit interfaces with a plurality of networks. In another embodiment, the plurality of networks are incompatible with each other. In an additional embodiment, the base unit further comprises an integrated display and user interface. In one embodiment, the base unit provides connectivity failover capability in the event a connection of the WWAN modem or the router fails. In another embodiment, the failover capability is provided by an Ethernet connection, or a 802.11 WLAN connection in a daisy chain configuration. The router, in some embodiments, provides a hotspot. In some embodiments the base unit further comprises a controller, and the transmitter receives content from the controller via a standard communications interface. In some embodiments, the standard communications interface is HDMI. In some embodiments, the router transmits the media content from the WWAN modem to the controller. In another embodiment, the base unit transmits different media content to different wireless receivers. In yet another embodiment, transmitter transmits to the first wireless receiver and a second wireless receiver, and the media content transmitted to the first wireless receiver is not necessarily substantially similar to the media content transmitted to the second wireless receiver. In one embodiment, the base unit further comprises a TV tuner device for receiving live video or audio content. In another embodiment, at least one of the wireless receivers is configured to transmit a wireless command to the transmitter to control the wireless media system.

In another embodiment, a method for distributing media content is provided. The method comprises receiving, over a WWAN network, the media content at a WWAN modem; transmitting, by way of a router, the media content from the WWAN modem to a controller; coordinating, using the controller, the delivery of the media content to one or more wireless receivers; and transmitting the media content to a first wireless receiver. In some embodiments, the modem and router are integrated with a base unit. In another embodiment, the method further comprises interfacing with a plurality of networks. In one embodiment, the plurality of networks are incompatible with each other. In some embodiments, the base unit further comprises an integrated display and user interface. In another embodiment, the method further comprises providing connectivity failover capability in the event a connection of the WWAN modem or the router fails. In one embodiment, the failover capability is provided by an Ethernet connection. In another embodiment, the method further comprises providing a hotspot. In an additional embodiment, the method further comprises receiving, at a transmitter, content from the controller via a standard communications interface. In some embodiments, the standard communications interface is HDMI. In some embodiments, the method further comprises transmitting, using a transmitter, different media content to different wireless receivers. In yet another embodiment, the method further comprises transmitting, using a transmitter, media content to a second wireless receiver, where the media content transmitted to the first wireless receiver is not necessarily substantially similar to the media content transmitted to the second wireless receiver. In another embodiment, the method further comprises receiving live video or audio content. In yet another embodiment, the method further comprises receiving, at the transmitter, a wireless command from at least one of the one or more wireless receivers to control the operation of a media content distributing base station.

### BRIEF DESCRIPTION OF THE DRAWINGS

FIG. 1 (PRIOR ART) is a block diagram illustrating a traditional digital signage system;

FIG. 2 is a block diagram illustrating a high level overview of an exemplary integrated wireless MobileMedia System;

FIG. 3 is a block diagram illustrating a detailed example of an integrated wireless MobileMedia System base unit;

FIG. 4 is a block diagram illustrating a detailed example of a MobileMedia System base unit ViFi Adapter Transmitter component;

FIG. 5 is a block diagram illustrating a detailed example of a MobileMedia System base unit Controller component to ViFi Adapter Transmitter component interface;

FIG. 6 is a block diagram illustrating a detailed example of a ViFi Adapter Receiver system component;

FIG. 7 is a flowchart illustrating steps of an exemplary method for providing integrated wireless MobileMedia service;

FIG. 8 depicts an overview of one embodiment of the end-to-end wireless MobileMedia System;

FIG. 9 depicts an embodiment where multiple ViFi adapter receivers wirelessly interface simultaneously with a single ViFi adapter transmitter;

FIG. 10 depicts an example of the MobileMedia System, where different content is simultaneously transmitted to different ViFi adapter receivers from a single ViFi adapter transmitter; and

FIG. 11 depicts an embodiment of a graphical user interface for the MobileMedia System.

FIG. 12 depicts an example of the MobileMedia System in a daisy-chain configuration to share one Internet connection amongst multiple MobileMedia Systems.

### DETAILED DESCRIPTION

The word “exemplary” is used exclusively herein to mean “serving as an example, instance, or illustration.” Any embodiment described herein as “exemplary” is not necessarily to be construed as preferred or advantageous over other embodiments.

The word “processor” is used herein to mean one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other electronic units designed to perform the functions described herein, or a combination thereof; including combinations of hardware, software, and/or firmware.

The apparatus and methodology disclosed herein is disclosed with reference to a WWAN, for example, a wireless network that utilizes mobile telecommunication cellular network technologies. Those of skill in the art will recognize that the apparatus and methodologies are applicable to many different types of WWANs and other types of wireless technologies, and may be used in, for example, a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a Worldwide Interoperability for Microwave Access (“WiMAX”) network, a Long Term Evolution (“LTE”) network (also known as fourth generation or “4G”), a network supporting a combination of the aforementioned technologies, a network with wide area network (“WAN”) coverage as well as wireless local area network (“WLAN”) coverage, or any other wireless or cellular networking scheme.

The present Integrated Wireless MobileMedia System is constructed to send and receive, in some embodiments, audio, video and data transmissions from wireless and wired infrastructures. This wireless analog and digital information is, in some embodiments, received stored, processed, encoded, compressed, and distributed via a wireless technology medium to both static and dynamic displays, such as televisions or food menus. The input signals can be, for example, via WWAN, WiFi and other wireless technologies with wired technology access as backup. The wireless distribution signal can be based on both open and closed source wireless technologies. These can include, for example, Wireless Personal Area Network Technologies (“WPAN”) such as IrDA, Bluetooth, Ultra Wideband (“UWB”), Wireless Home Digital Interface (“WHDI”), WirelessHD, Z-Wave and ZigBee; Wireless Local Area Network technologies (“WLAN”) such as WiFi (described in detail as IEEE standard 802.11), WWAN, and/or new and emerging wireless technologies. These signals can be unicast for point to point (single point) or multipoint solutions. The solution also enables multicast; multiple data streams to multiple end points.

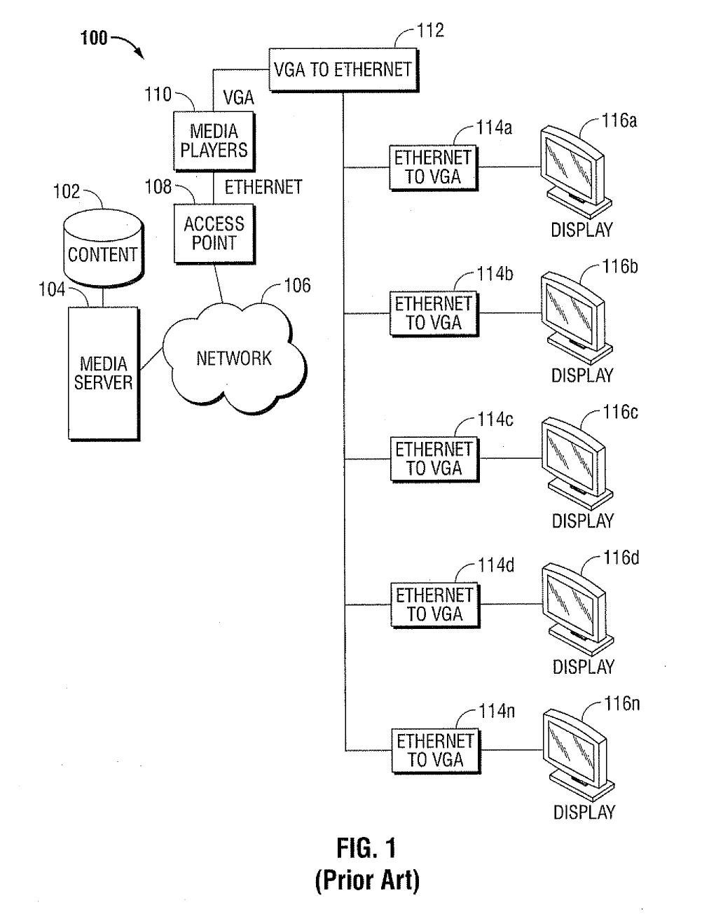

FIG. 1 is a simplified diagram illustrating typical digital signage system prior art 100. Advertising content from a storage device 102 is provided to a communications network 106 by media server 104. Communications network 106 is shown, for illustrative purposes, as an off site Internet Service Provider (“ISP”). A business site network access point 108 is configured to receive advertising content provided by the media server 104 for input to a local media player 110. The media player 110 outputs an analog Video Graphics Array (“VGA”) signal to a VGA to Ethernet converter 112 for distribution on the business site's LAN. The advertising content is transferred from the LAN to one or more Ethernet to VGA converters 114 associated with individual displays 116 for customer presentation.

The business site must be permanently hard wired for Internet access and networking. Many business sites do not have the option to utilize existing landline communications or are unsuitable for network installations. Media players 110, converters 114, operating systems and memory storage devices are required for each display 116. The required extraneous devices (108, 110, 112, 114) and business site LAN are costly to install and maintain. Furthermore, the hardwired displays 116 are not readily re-locatable within the retail environment where merchandise is often changed, moved, or redisplayed in a new or different manner. Likewise, the entire system cannot be relocated, for example, for use as traveling convention kiosks or to a new or expanded storefront, common carrier transportation, or other mobile applications.

Variations of the traditional digital signage system of FIG. 1 are also known in the art. Some such systems are only partially wireless and therefore not fully mobile, require micro-computers and or other equipment at each display and are therefore not completely integrated, and/or employ low quality transmission methods for audio, video and data content.

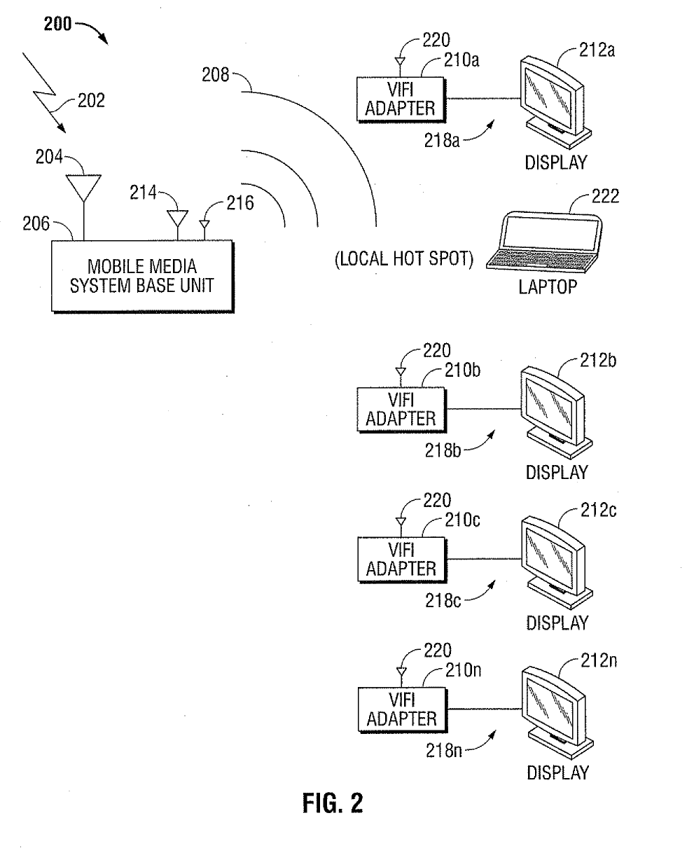

FIG. 2 is a block diagram illustrating a high level overview of an exemplary fully integrated wireless MobileMedia System 200 according to one embodiment. A MobileMedia System base unit 206 receives WWAN communication signal 202 carrying multi-media content at WWAN antenna 204. In some embodiments, the base unit 206 further receives audio/video signals using TV Tuner 324. These signals may be, for example, over the air signals received by antenna 326 or cable or satellite signals received by, for example, a satellite dish or cable TV convertor box 325 or standard HDMI, coaxial, component, S-Video, or composite cables from a closed-circuit feed or video. MobileMedia System base unit 206 stores, sorts and schedules the received content for transmission 208 from Video-over-WiFi (“ViFi”) capable antenna 216 to individual ViFi adapters 210 via antenna 220, which are communicatively coupled 218 to one or more associated displays 212. Internet data signals are received and transmitted from WiFi antenna 214 creating local wireless hotspot Internet connectivity for one or more Laptop or other computers 222 having a wireless modem. WWAN antennas (e.g., 204, 214, 216 and 220) may comprise a single or multiple antenna configurations. That is, in one embodiment MIMO technology is utilized and the antenna is constructed with more than one physical antenna. As one example, there are three antennas 216 on the MMS 206, and three antennas 220 on the ViFi adapter 314. The 802.11n specification allows up to four transmit antennas (on the MMS 206) and four receive antennas (on the ViFi adapter 314).

WiFi is a wireless-technology brand owned by the WiFi Alliance, which promotes standards with the aim of improving the interoperability of wireless local area network products based on the IEEE 802.11 standards. Common applications for WiFi include Internet and VoIP phone access, gaming, and network connectivity for consumer electronics such as televisions, DVD players, and digital cameras. A WiFi-enabled device such as a PC, game console, cell phone, MP3 player or PDA can connect to the Internet when within range of a wireless network connected to the Internet. The coverage of one or more interconnected access points, called a hotspot, can comprise an area as small as a single room with wireless-opaque walls or as large as many square miles covered by overlapping access points. WiFi also allows connectivity in peer-to-peer (wireless ad-hoc network) mode, which enables devices to connect directly with each other. This connectivity mode can prove useful in consumer electronics and gaming applications. WiFi allows LANs to be deployed without cabling for client devices, typically reducing the costs of network deployment and expansion. Spaces where cables cannot be run, such as outdoor areas and historical buildings, can host wireless LANs.

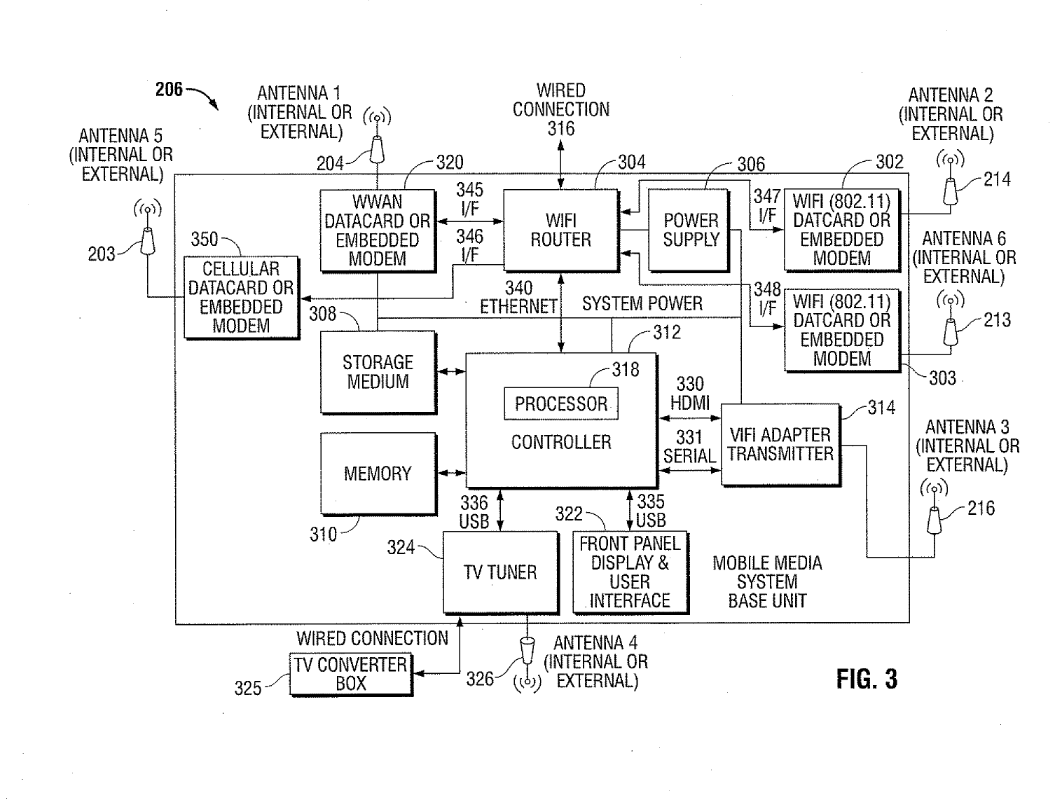

In one embodiment, the content and data communication protocol of the MobileMedia System base unit 206 is ViFi, utilizing, for example, the IEEE 802.11(n), 802.11(ac), or 802.11 (ad) standards. IEEE 802.11(n) is a proposed amendment which improves upon the previous 802.11 standards by adding Multiple-Input Multiple-Output (“MIMO”) and many other newer features including 40 MHz operation to the physical layer. MIMO uses multiple transmitter and receiver antenna configurations to improve the system performance. 40 MHz operation uses wider bandwidth (compared to 20 MHz bandwidth in legacy 802.11 operation) to support higher data rates. These higher data rates enable real time JPEG2000 video compression in concert with MIMO high definition video streaming, audio streaming by the MobileMedia System base unit 206. Embodiments of the MobileMedia System base unit 206 are detailed in FIG. 3.

FIG. 3 is a block diagram illustrating a detailed example of an integrated wireless MobileMedia System base unit 206. As shown, the MobileMedia System base unit 206 is designed to send and receive RF signals, for example, via a Third Generation (“3G”) WWAN antenna 204, a wired back-up 316, or a WLAN antenna 214. As discussed above, in some embodiments the base unit 206 is also designed to receive audio/video signals, such as via a satellite or over the air via TV Tuner 324. The received content is, in some embodiments, downloaded to memory 310 and/or storage medium 308 for layering, or application sorting, and scheduling. This information is then processed, encoded and compressed in real time during media playback. The encoded information is, in some embodiments, transmitted via wireless technology, for example: WPAN, WLAN, and WWAN as well as new and emerging wireless technologies to designated display receivers.

In some embodiments, content and data are received via WWAN antenna 1 204 for processing by WWAN modem 320. For example, content authored in New York can be sent over a wired or wireless network to a MobileMedia System located Los Angeles by directing the content to an IP address of the modem 320. In some embodiments, the combination of antenna 1 204 and WWAN modem 320 provides the base unit 206 with its primary network connection. WWAN modem 320 may be an Application Specific Integrated Circuit (“ASIC”), WWAN data card, embedded module, modem board, or any other means for receiving WWAN radio access technologies. In one embodiment, modem 320 is a standard data card provided by one or more existing vendor(s). In some embodiments, modem 320 supports 3G or similar wireless technologies. Those of ordinary skill in the art will recognize that modem 320 may also support more advanced wireless technologies, either now in development or developed in the future, provided such technologies are operable with the application usage techniques described herein.

Wi-Fi router 304, in some embodiments, is a complete networking router providing multiple connectivity options. For example, in some embodiments, router 304 connects to wireless network, such as a Wi-Fi network through the WLAN modem 302 via antenna 214 or WWAN network through the 3G modem 320 via antenna 204. In some embodiments, in addition to or instead of connecting to a wireless network, router 304 connects to a wired network, such as a wired Ethernet network, via wired connection 316. Wired connection 316 may be, for example, an Ethernet cable or fiber optic cable. Router 304 provides, in some embodiments, the functionality for providing billable Wi-Fi services, content filtering, SMS/Short-code messaging, remote management, and maintenance. In some embodiments, the router 304 determines which requests are routed directly to the Internet (e.g. WiFi Hotspot traffic), and those requests that are directed to the controller 312 (e.g. new content downloads, or maintenance/diagnostic requests). Further, in some embodiments, the router 304 re-routes WiFi Hotspot traffic to Radius servers to authenticate, authorize, and bill users, and to content filtering servers to block any undesirable content from being displayed at a WiFi Hotspot.

TV Tuner 324 is, in some embodiments, a simple TV tuner card that receives over the air analog or digital television transmissions via antenna 326. In other embodiments, TV Tuner 324 provides some or all of the capabilities of modern television set-top boxes, including, for example, the ability to receive satellite or cable television signals, provide on-screen display of content and program scheduling, provide DVR recording capabilities, provide on-demand functions, provide high definition recording and output capability, etc.

In some embodiments, modem 320, modem 302, router 304, and/or TV Tuner 324 are implemented as stand alone, free standing products that are separate from the base unit 206. In other embodiments, modem 320, modem 302, router 304, and TV Tuner 324 are integrated into and are part of the base unit 206. In this embodiment, the base unit 206 can be purchased as a single unit, permitting easy installation and setup, and reducing the overall cost of the system.

The content received by modem 320, modem 302, Wi-Fi router 304, and/or TV Tuner 324 is, in some embodiments, stored on storage medium 308 and/or memory 310 or transmitted to one or more displays in real time. Storage medium 308 may comprise a hard disk drive, floppy disk, optical disk, magnetic tape, or any other storage medium.

Processor 318 based controller 312, communicatively coupled, in some embodiments, to modem 320, storage medium 308, memory 310, WiFi router 304, ViFi adapter transmitter 314, TV Tuner 324, and front panel display and/or user interface 322, supports an operating system and user applications for sorting received content and scheduling display transmissions. The controller 312, in some embodiments, schedules and manages all activities of the MobileMedia System. In some embodiments, in conjunction with content management software, the controller 312 stores content onto the storage medium 308, determines which displays 212 shall receive what content, how long the content will be displayed, and how frequently the content will be updated. In addition, in some embodiments, the controller 312 enables user of the MobileMedia System to perform maintenance and diagnostics on the controller 312, wireless adapters, and displays 212. In some embodiments, the controller 312 also interprets commands and information sent from a display 212 to the controller 312 via the ViFi adapter transmitter/receiver 314. Such commands and information may pertain to, for example, maintenance, diagnostics, or content control of the MobileMedia System, and/or user interaction at the display 212. In some embodiments, the controller 312 also acts as the interface to any remote content servers wanting to push new content to the controller 312 and to any remote maintenance servers for monitoring and diagnostic purposes. In some embodiments, controller 312 is a standard PC mother board and supports media content and management software.

Controller 312 is, in some embodiments, coupled to WiFi router 304 and/or other components of the base unit 206 using a wired Ethernet connection 340 or other communication interface. In these embodiments, network traffic from the router 304 (wireless or wired) may be routed to the controller 312, permitting the controller 312 to receive data pertaining to the content being provided by the MobileMedia System. The controller 312 can communicate using other industry standard communication interfaces and standards, such as Composite, VGA, DVI, HDMI, DisplayPort, UDI, firewire, USB, serial, etc. In some embodiments, data that is delivered to the modem 320 via the antenna 204, or modem 302 via antenna 214, is delivered over a hardware interface directly to the controller 312. In other embodiments, the data is delivered from the modem 320 to the router 304 over I/F 345, from the modem 302 to the router 304 over I/F 346. The router 304 thereafter transmits the data to the controller 320 via the controller's Ethernet connection 340.

The processor 318 operates according to executable instructions fetched from memory 310. The memory 310 may be RAM memory, flash memory, ROM memory, EPROM memory, EEPROM memory, registers, a removable disk, a CD-ROM, or any other form of storage medium known in the art. Exemplary user applications executed by the processor 318 include logo applications, point of sale advertising applications, point of sale promotions applications, games, entertainment, information applications, operating room applications, digital menus, or any digital signage application.

Power to all the MobileMedia System base unit 206 components is, in some embodiments, provided by the power supply 306, which may be a standard PC power supply.

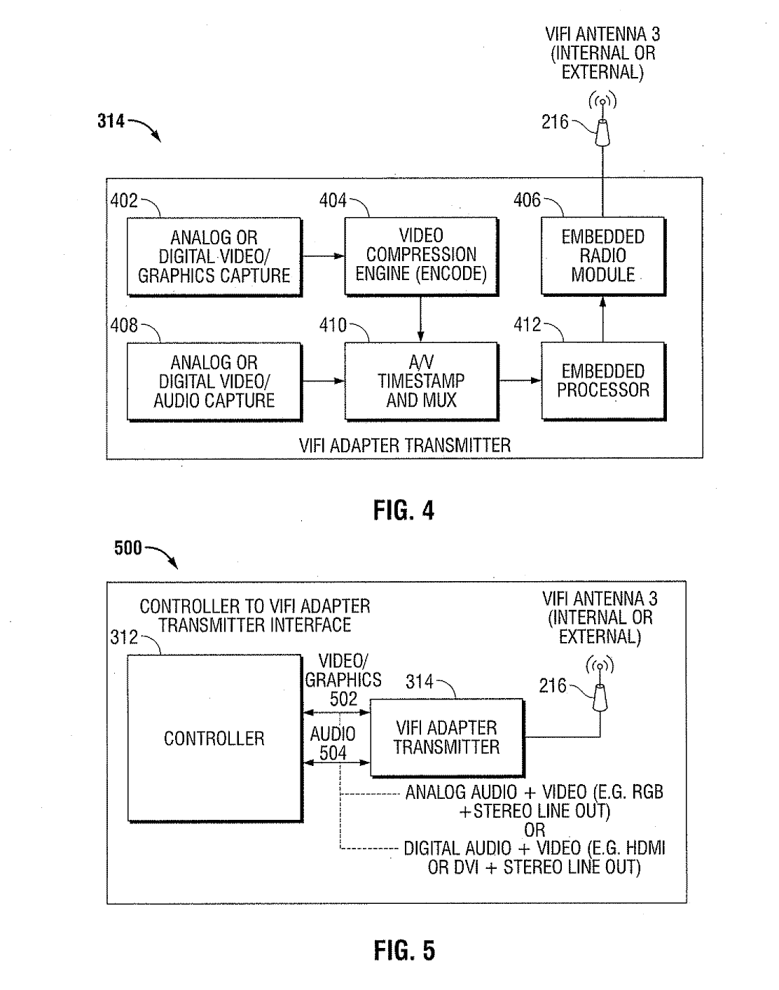

Content and data sorted and scheduled by the controller 312 are transmitted to system displays, in some embodiments, by the ViFi adapter transmitter 314 via the antenna 3 216 and to local wireless hot spot devices by the WiFi router 304 through the modem 320 via the antenna 2 214. Various embodiments of the ViFi adapter transmitter 314 are detailed in FIG. 4.

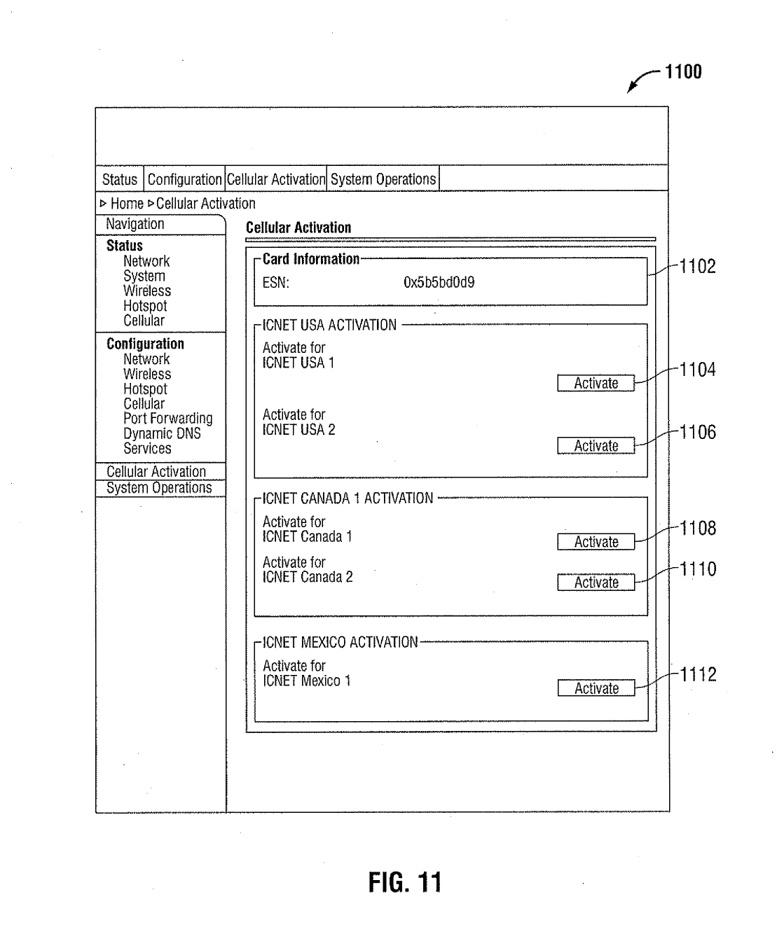

Front panel display and user interface 322 provides a local interface enabling direct user access to user applications and content stored in storage medium 308. Users may locally modify and schedule content display and perform other managerial tasks without any external connectivity. Front panel display and user interface 322 comprises pushbuttons for System Status Monitoring, and Control and Configuration. For instance, in one embodiment the front panel display and user interface 322 provides access to 3G signal strength information. In one embodiment, the display is a 4-line alphanumeric display with pushbuttons and/or a small keyboard for user control. In other embodiments, the display 322 is a Graphics LCD, touch screen, OLED, etc., that is, in some embodiments, interfaced with the controller 312 via USB connection 335. One embodiment of the user interface 322, as accessed from an external device, is detailed in FIG. 11.

In one embodiment, the MobileMedia System base unit 206 supports the following technical features:
802.11n Radio (WLAN) for transmitting High Definition (HD) quality audio/video or graphics by supporting approximately 100 to 600 Mbps transmission bandwidth within the 5 GHz radio frequency band.
Network Issued/DHCP IP Address assignment necessary to support multi-user web surfing and video content on display as well as for broadcasting same video to multiple displays connected to a single MobileMedia System.
3G Network Interface via Embedded WWAN Module.
160+GB hard disk drive or equivalent solid state drive (SSD).
Linux or Microsoft based Operating System.
   It will be appreciated by those skilled in the art that various embodiments of the MobileMedia System base unit 206 may implement a variety of alternative technical features.

In some embodiments, the base unit 206 interfaces with carriers and/or telcos operating different types of networks or using specific types of WWAN modems. For example, the combination of modem 320 and router 304 permits the activation, command, and transfer of data to and from different wireless data providers, such as Sprint, AT&T, and Verizon WWAN providers, and Wi-Fi providers, such as T-Mobile Hotspot, which all generally operate using unique and generally incompatible wireless technologies and/or modems. In addition, modem 320 and/or router 304 also allow the activation, command, and transfer of data to and from wired providers, such as Comcast.

In some embodiments the modem 320 includes GPS functionality. For example, many 3G modems include GPS functionality. The GPS functionality can be utilized in mobile or non-mobile applications of the MobileMedia System. As one example, the GPS functionality can be used when the MobileMedia System is implemented on a train. In this embodiment, location information from the GPS system can trigger location based advertising (e.g., during a trip from Los Angeles to San Diego, Los Angeles based advertising will run when the train is in the Los Angeles area and San Diego based advertising will be displayed when the train is in the San Diego area.) As another example, location based information could be provided to passengers on the train through one of the displays. In this example, a notification could be provided on the display showing the estimated arrival time to the next train station (e.g., on a train, the display could indicate that Union Station is approaching in 10 minutes). Many other types of location based advertising or information can also be displayed or implemented using the GPS functionality.

In some embodiments, the base unit 206 serves as a HotSpot, such as a WiFi HotSpot. Since 3G and 802.11g (a standard used for the HotSpot) can operate in different frequencies, both technologies can operate in close proximity to each other without suffering interference. For instance, in some embodiments, the MobileMedia System utilizes a 3G Internet interface provided via modem 320 to provide data and Internet content to the base unit 206, which in turn can provide such data and Internet content to users via modem 302 connected to router 304. The MobileMedia System therefore can provide users connected to the base unit 206 via the antenna 214 a seamless connection to the Internet via modem 320. Similar arrangements can also be provided for a wired Internet connection provided via the router 304.

In some embodiments, the MobileMedia System has failover capability. For example, in some embodiments modem 320 provides a primary Internet connection via a 30 wireless connection, while router 304 provides secondary Internet connections via the wired connection 316, the WLAN modem 302, a secondary WLAN modem 303, or a secondary 3G wireless connection 350. If the primary connection Internet connection 204 fails, MobileMedia System automatically switches to a secondary Internet connection for data and Internet connectivity. The MobileMedia System is therefore capable of providing Internet failover capability using only one, or in some embodiments no wired connection.

The secondary 3G wireless connection 350 is optional and can be used, for example, in mobile applications of the MobileMedia system. For example, if the MobileMedia system 206 is installed on an Amtrak train the first 30 wireless connection 320 can be implemented as an AT&T compatible wireless modem and the second 30 wireless connection 350 can be implemented as a Verizon compatible wireless modem. If AT&T does not have service in a specific area, the secondary 3G wireless connection 350 will be used so long as Verizon has coverage in that area. In this manner, a back-up 3G wireless connection is provided. The optional second 3G wireless connection 350 can be implemented as a back-up 3G wireless connection in any other application where a fail-over connection is desirable (e.g., in mobile or non-mobile systems).

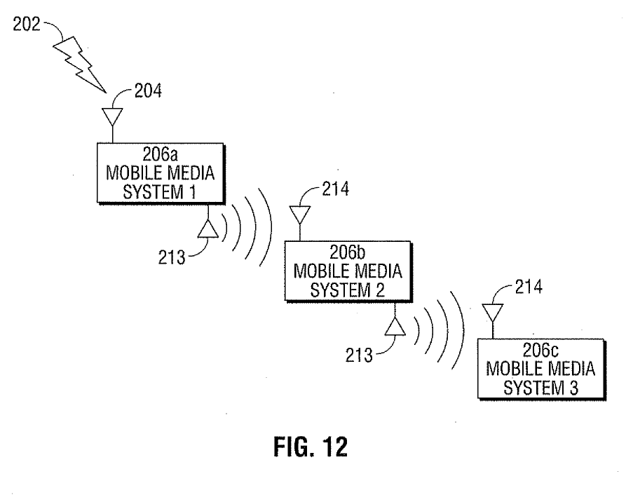

The secondary WLAN modem 303 is optional and can be use, for example, to daisy chain multiple MobileMedia systems (or base units 206) together. (This embodiment is further described below with reference to FIG. 12.) In this instance, the first WLAN modem 302 provides a hot spot for people accessing the Internet, while the second WLAN modem 303 provides a connection between multiple MobileMedia systems. Either WLAN modem can provide either service. That is, the first WLAN modem 302 can either provide Internet service or the daisy chain connection to a second MobileMedia system.

Referring now to FIG. 12, depicted are embodiments of the MobileMedia System in a daisy chain configuration. As discussed above, embodiments of the MobileMedia System can access the Internet via a 3G wireless connection, a wired Ethernet connection, or a 802.11 WLAN connection. In a daisy chain configuration, a second MobileMedia System 206b may rely on a first MobileMedia System 206a for the Internet connection. For example, by having the first MobileMedia System 206a act as an access point, the Internet connection 204 of the first MobileMedia System 206a (such as via a 3G wireless connection or a wired Ethernet connection) is shared with the second MobileMedia System 206b. In this embodiment, the WLAN modem 302 (shown in FIG. 3) in the second MobileMedia System 206b acts as client, instead of an access point, and obtains an Internet connection from the first MobileMedia System 206a through the 802.11 WLAN connection. In some embodiments, additional MobileMedia Systems (e.g., the third MobileMedia System 206c) repeat the daisy chain configuration by acting as clients off of the second MobileMedia System 206b or off of the first MobileMedia System 206a.

FIG. 4 is a block diagram illustrating a detailed example of a base unit ViFi adapter transmitter 314. ViFi adapter transmitter 314, in some embodiments, enables cached High Definition (HD) audio/video or graphics content to be streamed over WiFi through multiple video outputs that enable displays on any monitor, TV, LCD, panel display or other viewing device. ViFi adapter transmitter 314, in some embodiments, allows distribution of digital media content from one source to multiple monitors completely wirelessly utilizing 802.11(n), later WiFi standards, and/or other standards.

ViFi adapter transmitter 314 is, in some embodiments, interfaced with the controller 312 via a communications channel, such as by using an HDMI interface 330 and associated HDMI cable. The ViFi adapter transmitter 314 obtains its power from the power supply 306. In some embodiments, components and firmware of the ViFi adapter transmitter 314 are configured over a serial interface 331 with the controller 312. In other embodiments, the components and firmware are configured using the HDMI interface, or wirelessly via the embedded radio module 406 and antenna 3 216. As shown, the ViFi adapter transmitter 314 is wirelessly connected to one or more remote ViFi adapter receivers 600 (discussed in more detail below) via the embedded radio module 406 and antenna 3 216.

In some embodiments, analog or digital video provided by controller 312 to video/graphics capture module 402 via HDMI or other means is encoded and compressed by video compression engine 404 for time stamping and multiplexing by AN timestamp MUX module 410. In one embodiment, JPEG2000 video compression is implemented by the compression engine 404 video encoding process. Analog or digital audio provided by controller 312 is, in some embodiments, directly time stamped and multiplexed by A/V timestamp MUX module 410. Further embodiments of the controller 312 to ViFi adapter transmitter 314 interface are detailed in FIG. 5.

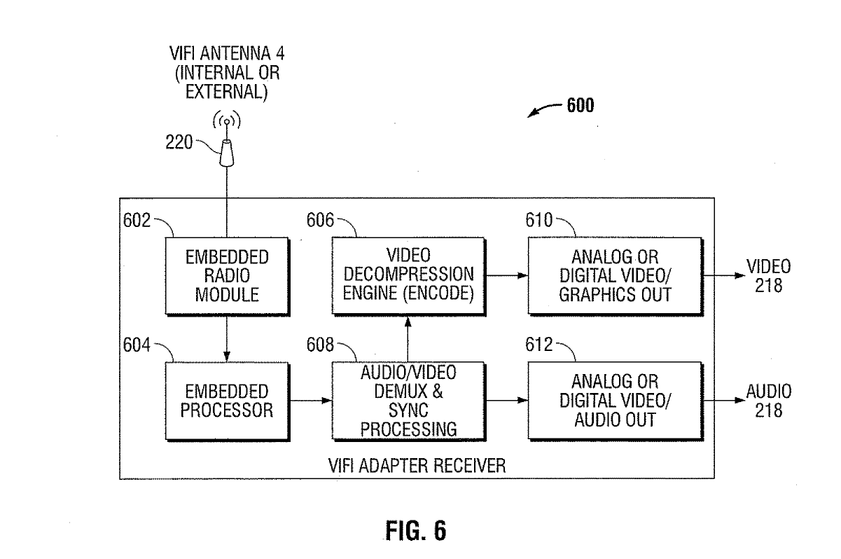

A/V timestamp MUX module 410, in some embodiments, outputs time stamped and multiplexed audio and encoded video to embedded processor 412, which controls 802.11(n) or later standard transmission by embedded radio module 406 via antenna 3 216. 802.11(n) standard signals are, in some embodiments, received by one or more ViFi adapter receivers 600 associated with individual system displays 212. Embodiments of a ViFi adapter receiver 600 are detailed in FIG. 6.

FIG. 5 is a block diagram illustrating a detailed example of a base unit controller 312 to ViFi adapter transmitter 314 interface 500. Controller 312 and ViFi adapter transmitter 314 are communicatively coupled by video/graphics bus 502 and audio bus 504. Video and graphics information exchanged between controller 312 and ViFi adapter transmitter 314 comprise analog audio and analog video (i.e. RGB) or digital audio and digital video (i.e. HDMI or DVI) or a combination of analog and digital outputs and inputs.

In some embodiments, ViFi adapter transmitter 314 is implemented as a stand alone, free standing product that is separate from the base unit 206. In other embodiments, ViFi adapter transmitter 314 is integrated into and is a part of the base unit 206, permitting the base unit 206 to be purchased as a single unit for easy installation, setup, and lowering costs.

FIG. 6 is a block diagram illustrating an embodiment of a ViFi adapter receiver 600. ViFi adapter receiver 600 receives a wireless signal from the ViFi adapter transmitter 314 and processes that signal for output to an audio/video device, such as an LCD panel or stereo receiver. In one embodiment, embedded radio module 602 receives encoded and compressed audio and video 802.11(n) or later standard streams from ViFi adapter transmitter 314 via ViFi antenna 4 220 and converts the signals for processing by embedded processor 604. WWAN antenna 220 may be a single or multiple antenna configuration. Embedded processor 604 outputs digitized audio and video signals to demux and sync processing module 608, which synchronizes time stamp information and de-multiplexes video and audio into separate signals. The video portion of the received signal is then decompressed and decoded by video decompression engine 606 for output 218 by video/graphics output module 610 to one or more displays or related a/v equipment. The audio portion of the received signal is output 218 to one or more audio/video devices, such as a stereo receiver or other type of audio equipment, by audio output module 612.

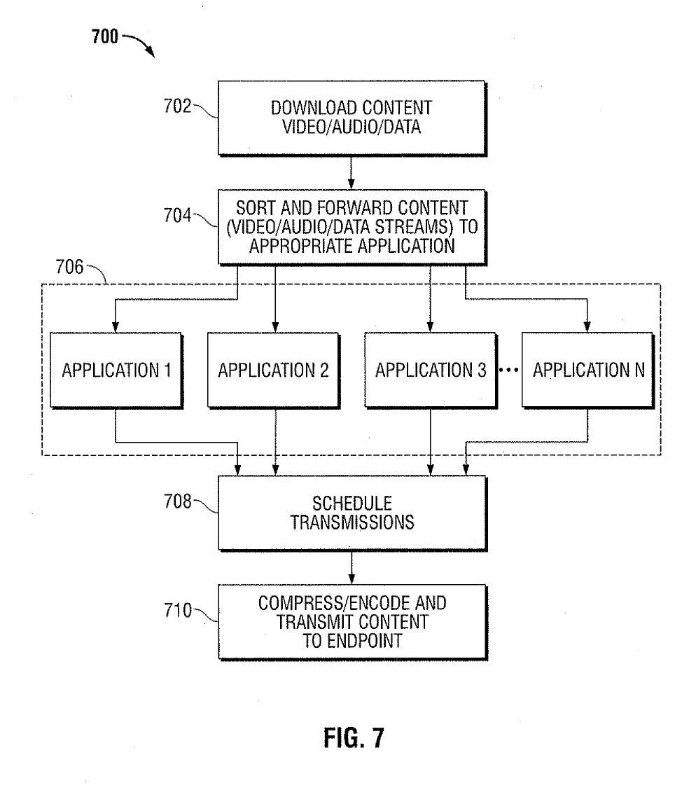

FIG. 7 is a flowchart illustrating steps of an exemplary method for providing integrated wireless MobileMedia service 700. Integrated wireless MobileMedia service allows completely wireless distribution of digital media content from one source to multiple monitors, thus providing multiple revenue channels per MobileMedia System as well as remote management and maintenance. Video content may be cached and scheduled for playback or delivered in real time. Content applications may include Ad-Injections and Persistent Banners, logos, games, news, entertainment, promotions or any other user specified application. The MobileMedia System is content agnostic—open to any of the various software technologies that content providers design with to create advertising and marketing messaging.

Processing begins in step 702 wherein a WWAN signal having content is received and downloaded to the MobileMedia System. Control flow proceeds to step 704.

In step 704, the received content is stored and sorted for input to an appropriate application. Control flow proceeds to step 706.

In step 706, the sorted content is received and forwarded to one or more appropriate applications. For example, logo content may be forwarded to a first application, banner content a second application, advertisement forwarded to a third application and sound bites to another application. Content may also comprise Internet data designated for local wireless hotspot devices. When the sorted content has been input to and processed by the appropriate application, the application requests scheduling of its content for transmission to a designated display(s). Control flow proceeds to step 708.

In step 708, content is scheduled for transmission to a designated audio/video device. Content may be scheduled for real time transmission or presentation from storage at a later time. Control flow proceeds to step 710.

In step 710, content is compressed, encoded and then transmitted to its designated endpoint. One skilled in the art will understand that ordering of steps illustrated in FIG. 7 is not limiting. The method is readily amended by omission or re-ordering of the steps illustrated without departing from the scope of the disclosed embodiments.

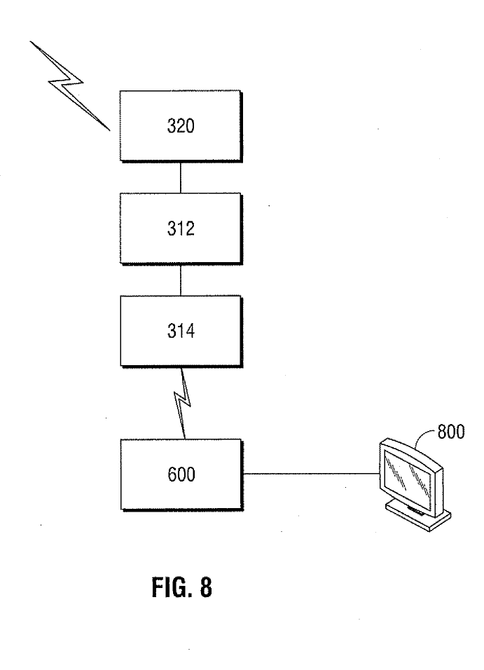

Referring now to FIG. 8, depicted is an overview of one embodiment of the end-to-end wireless MobileMedia System. As depicted, an incoming wireless signal containing audio and/or video is received at modem 320. The data from the signal is then transferred to the controller 312, which converts the data into audio and/or video and directs the audio and video to ViFi adapter transmitter 314. The ViFi adapter transmitter then converts the audio and video for transmission and sends the a/v signal wirelessly to one or more ViFi adapter receivers 600. The ViFi adapter receivers 600 convert the wireless a/v signal back to audio and video, and directs the audio and video to one or more displays 800 or similar audio/video devices to be viewed/heard by an end user.

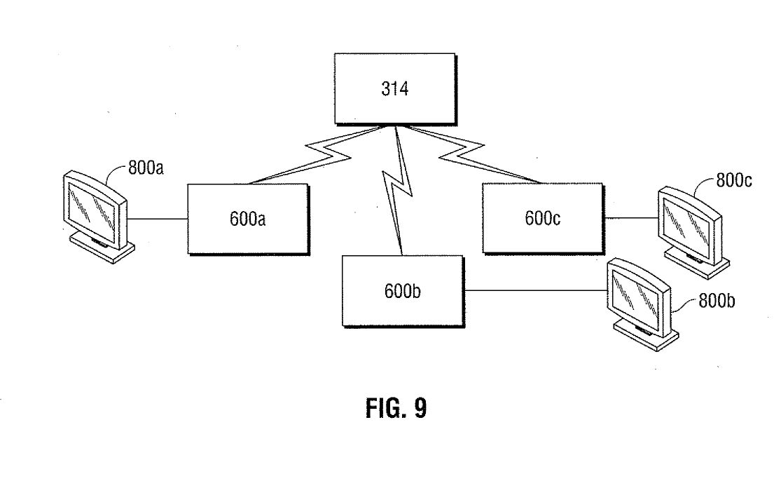

As is apparent from the above discussion, and as illustrated in FIG. 9, multiple ViFi adapter receivers 600a-c may interface simultaneously with a single ViFi adapter transmitter 314. This arrangement permits the MobileMedia System to simultaneously transmit content to multiple display devices 800a-c from a single base unit 206. The combination of a base unit 206 and multiple ViFi adapter receivers 600a-e thus results in an extremely powerful and unique media distribution system. In some embodiments, this is accomplished by setting the outbound address of the ViFi adapter transmitter 314 to a broadcast address. In this manner, each ViFi adapter receiver 600a-c will receive the data from the ViFi adapter transmitter 314.

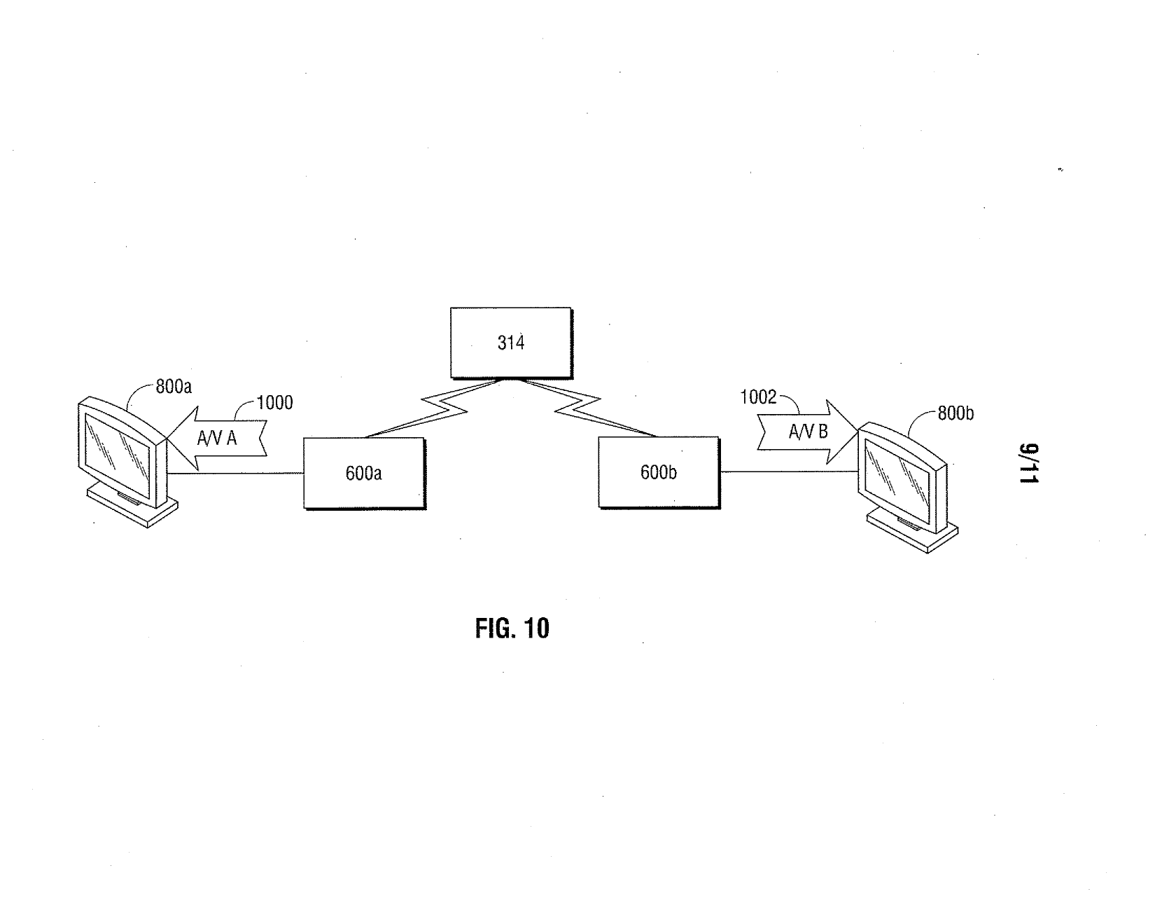

Further, as depicted in FIG. 10, the MobileMedia System, in some embodiments, simultaneously transmits different content to different ViFi adapter receivers 600a-b from a single ViFi adapter transmitter 314. For instance, audio/video content a 1000, such as a commercial, is transmitted from ViFi adapter transmitter 314 to ViFi adapter receiver 600a at the same time that audio/video content b 1002, such as flight status information, is transmitted from ViFi adapter transmitter 314 to ViFi adapter receiver 600b. Thus, display 800a, which is interfaced with ViFi adapter receiver 600a, displays audio/video content a 1000, while display 800b, which is interfaced with ViFi adapter receiver 600b, displays audio/video content b 1002.

In some embodiments, the ViFi adapter transmitter 314 is provided with firmware enabled to allow unique content targeted towards a specific display 800. This firmware, working in conjunction with content management software, takes advantage of pauses in content display (for example, when a still image is displayed for a fixed period of time) to send new content to the next display 900. As an example, given displays 800a-c, each receiving unique content composed of 30 seconds of still images and 15 seconds of full motion, ViFi adapter transmitter 314 operates, in some embodiments, as follows:
(a) During a first transmission period, ViFi adapter transmitter 314 transmits full motion content for 15 seconds to display 800a, while sending a single still image to displays 800b and 800c for display during this period.
(b) A second transmission period follows the first 15 second transmission. During this period, the ViFi adapter transmitter 314 transmits a single still image to display 800a for display, and transmits 15 seconds of full motion content to display 800b. Display 800c continues to display the original still image provided to it during the first transmission period.
(c) In a third transmission period following the second 15 second transmission period, the ViFi adapter transmitter 314 transmits a single still image to display 800b for display, and transmits 15 seconds of full motion content to display 800c. Display 800a continues to display the still image transmitted to it during the second transmission period.
(d) The cycle then repeats per a pre-defined schedule. In some embodiments, the content (still and full motion) provided to each display 800a-c is unique at each display (i.e. each display has different content).

Referring now to FIGS. 3, 6 and 8, in some embodiments, the MobileMedia System provides wireless command and control using HDMI. For instance, HDMI data, including program content and/or HDCP handshake data, at the base unit 206 is transmitted as a wireless data stream using the ViFi adapter transmitter 314. Once received at a ViFi adapter receiver 600, the data stream returns to a normal wired HDMI signal and is then provided to one or more HDMI capable displays. Likewise, HDCP handshake information transmitted by an HDMI compliant display is received and transmitted wirelessly by the ViFi adapter receiver 600 to the ViFi adapter transmitter 314, which then returns the wireless signal to its normal wired state and transmits it to the controller 312 as part of the HDMI handshake process. Thus, the underlying HDMI data can be transmitted and received over a wireless interface in its native format without requiring data conversions or other processor intensive or complicated procedures.

In some embodiments, wireless command and control using HDMI uses the vendor specific data structure (“VSD”) provided within the E-EDID data structures of the HDMI 1.3a specification. The VSD data structure is used as a two way transport vehicle to send and receive wireless information. When transmissions are sent from the ViFi adapter transmitter 314 to the ViFi adapter receiver 600, or vice versa, wireless specific information is included in the VSD structure to facilitate the wireless transmissions.

Similar transmission methods are applicable to other data signal protocols, such as USB, Serial, Ethernet, or Firewire, and can be utilized for both wireless and wired transmissions. For instance, a USB signal can be handled in essentially the same manner as the HDMI signal discussed above. In addition, the HDMI protocol and interface, in some embodiments, are used to transmit data pertaining to other protocols, such as USB, Serial, Ethernet, or Firewire. This is accomplished, in some embodiments, by transmitting the data of the protocol, such as USB, in the same VSD data structure discussed above.

In some embodiments, other data signal protocols, such as those described above, are used to provide RS232 or USB capabilities to displays, or connect touch-screens, or external cameras to displays. RS232 or USB connections are utilized in some displays to control the display with functions such as on, off, volume up, volume down, mute, color, contrast, brightness, and obtain diagnostic and performance information from the display. In these instances, a wired connection from the display is, in some embodiments, connected to either the MobileMedia System or ViFi Adapter to provide this capability. The MobileMedia System, in some embodiments, hosts content management software or a standalone application that issues the control commands to the display. If the display is connected directly to the MobileMedia System, the control commands are issued directly to the display via any of the various interfaces (USB, Firewire, Serial, HDMI, etc.) discussed above. Using the methods previously described, in one embodiment, if the display is connected to a ViFi adapter, the control commands are issued by the content management software or standalone application to the transmitter within the MobileMedia System, the ViFi adapter receives these commands and passes the commands to the display. The display can also provide information such as diagnostic data to the MobileMedia System. The process for sharing this information is the reverse of the MobileMedia System issuing control commands. The use of touch screens or cameras follow the same connections and processes as control commands and diagnostic data previously described.

In some embodiments, the MobileMedia System dynamically optimizes its transmissions. For instance, in some embodiments, when the maximum wireless bandwidth available to the ViFi adapter transmitter 314 is met or exceeded, the data being transmitted is recompressed into a lower bitrate or the resolution of the broadcast lowered to provide additional simultaneous data transmissions. As those of ordinary skill in the art will recognize, the above solutions may lower the perceived quality of the displayed content. Therefore, in other embodiments, once the bandwidth available to the ViFi adapter transmitter 314 has been met, additional transmissions are not initiated by the MobileMedia System. A message to any affected ViFi adapter receiver 600 and corresponding displays may read, for example, “Not enough bandwidth to support your transmission.” In some embodiments, a queue may be formed of waiting transmissions and/or ViFi adapter receivers 600, and once additional bandwidth becomes available, the transmission at the head of the queue is automatically transmitted normally and/or the ViFi adapter receiver 600 at the head of the queue is transmitted to.

As depicted in FIG. 11, the MobileMedia System is, in some embodiments, configured to work and be activated with multiple wired and/or wireless data providers using a single graphical user interface 1100. For instance, modem 320 and or router 304 configuration and identification information is available and can be edited through tab 1102. Carriers and/or telcos are also easily added, removed, and configured by a user of the interface 1100. For instance, a user may use the interface 1100 to input into the MobileMedia System a new carrier, including carrier location, carrier name, wireless type, service plan account information, service access information, etc. for a given carrier/telco. After the carrier/telco has been added to system, in some embodiments, the services of the carrier/telco can easily be activated and utilized by clicking an activation tab 1104-1112 on the interface 1100 corresponding to the carrier/telco. For instance, clicking activation tab 1104 will automatically activate the ICNET USA 1 carrier service. Carriers/telcos and their respective activation tabs 1104-1112 can be added or removed by a user as necessary.

In some embodiments, the MobileMedia System is utilized in a medical setting. The system is, in some embodiments, connected to wireless or wired health monitors, and/or to camera wands or other devices through USB, HDMI, etc. The MobileMedia System thereafter, for example, saves and/or transmits the operating room data it receives to third parties, using the methods and systems described in detail above.

In another embodiment, the MobileMedia System is utilized in a waiting room setting. Once a patient enters a hospital waiting room, the patient's information is input into a system (either by an employee of the hospital or by the patient using a touch-pad device), and then transmitted using WiFi, WWAN, or wired technologies, for example, to the MobileMedia System. Thereafter, the data is propagated by the MobileMedia System throughout the hospital or its system using the various methods and systems discussed in detail above.

In another embodiment, the MobileMedia System is utilized to provide a digital menu, such as a restaurant menu. The MobileMedia System, using the methods and systems discussed above, transmits menu items, ads, etc. to digital tablets, which are provided to users. The users may use a touch screen of the tablet to order food, request the bill, play interactive games, etc. The request, such as an order, is transmitted to the controller 312 of the base unit 206, which thereafter coordinates the order processing, such as by giving a food order to the restaurant chef, or requesting a waiter to come to the user's table. In some embodiments, food orders are transmitted wirelessly from the base unit 206 to one or more display screens in the kitchen of the restaurant. Digital signage located throughout the restaurant, for example, is also integrated into the MobileMedia System. In some embodiments, the digital signage displays advertisements based on what customers are ordering. In other embodiments, the signage displays interactive games, such as trivia games, that the customers play along with using their digital tablets.

In other embodiments, the MobileMedia System is utilized to provide digital signage on transportation vehicles. For instance, a MobileMedia System located on a train communicates with a central routing system to obtain location information for the train, and thereafter wirelessly transmits content to digital signage located on the train. Such content may include, for example, current location information, or location based advertisements.

In other embodiments, the MobileMedia System is utilized in emergency situations. For instance, referring now to FIG. 3, the controller 312 is, in some embodiments, connected via wired or wireless connection to an alarm system to receive warning messages from the alarm system. For instance, the warning messages can be delivered by conventional computing methods such as SNMP messages. Based on the message received, the controller 312, in some embodiments, selects an appropriate message already stored in the storage medium 308 and, utilizing the ViFi adapter transmitter 314, wirelessly transmits the pre-stored message to one or more multiple ViFi adapter receivers 600. The MobileMedia System can therefore provide emergency messages to multiple display devices in efficient and cost effective manner.

In another embodiment, the MobileMedia System provides for triggered actions. For example, at the end of a basketball game, upon the playing of an “end of game” horn, media stored in storage media 308 is retrieved and transmitted for display. In some embodiments, the MobileMedia System is connected, via a wired or wireless connection, to an external triggering system, such as a score board or horn. The trigger may be, for example, in the form of SNMP packets, or be an audible sound. Based on the trigger received, the controller 312, in some embodiments, selects an appropriate message already stored in the storage medium 308 and, utilizing the ViFi adapter transmitter 314, wirelessly transmits the pre-stored message to one or more multiple ViFi adapter receivers 600.

Thus, a novel and improved method and apparatus for an integrated wireless multimedia system have been described. Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a system base unit.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A wireless media system comprising:
a base unit comprising:
a wireless wide area network (“WWAN”) modem for receiving media content over a WWAN;
a router in communication with the WWAN modem; and
a transmitter for wirelessly transmitting the media content to one or more wireless receivers, wherein a first wireless receiver is configured to wirelessly receive the media content from the transmitter and push the media content to a video display device.

2. The system of claim 1, wherein the modem and router are integrated with the base unit.

3. The system of claim 1, wherein the base unit interfaces with a plurality of networks.

4. The system of claim 3, wherein the plurality of networks are incompatible with each other.

5. The system of claim 1, wherein the base unit further comprises an integrated display and user interface.

6. The system of claim 1, wherein the base unit provides connectivity failover capability in the event a connection of the WWAN modem or the router fails.

7. The system of claim 6, wherein the failover capability is provided by a wired connection.

8. The system of claim 1, wherein the router provides a hotspot.

9. The system of claim 1, wherein the base unit further comprises a controller, and wherein the transmitter receives content from the controller via a standard communications interface.

10. The system of claim 9, wherein the standard communications interface is HDMI.

11. The system of claim 1, wherein the base unit further comprises a controller, and wherein the router transmits the media content from the WWAN modem to the controller.

12. The system of claim 1, wherein the base unit transmits different media content to different wireless receivers.

13. The system of claim 1, wherein the transmitter transmits to the first wireless receiver and a second wireless receiver, and wherein media content transmitted to the first wireless receiver is not necessarily substantially similar to media content transmitted to the second wireless receiver.

14. The system of claim 1, wherein the base unit further comprises a TV tuner device for receiving live audio or video content.

15. The system of claim 1, wherein at least one of the wireless receivers is configured to transmit a wireless command to the transmitter to control the wireless media system.

16. A method for distributing media content comprising:
receiving, over a wireless wide area network (“WWAN”), media content at a WWAN modem;
transmitting, by way of a router, the media content from the WWAN modem to a controller;
coordinating, using the controller, the delivery of the media content to one or more wireless receivers; and
transmitting the media content to a first wireless receiver.

17. The method of claim 16, wherein the modem and router are integrated with a base unit.

18. The method of claim 16, further comprising interfacing with a plurality of networks.

19. The method of claim 18, wherein the plurality of networks are incompatible with each other.

20. The method of claim 17, wherein the base unit further comprises an integrated display and user interface.

21. The method of claim 16, further comprising providing connectivity failover capability in the event a connection of the WWAN modem or the router fails.

22. The method of claim 21, wherein the failover capability is provided by an ethernet connection.

23. The method of claim 16, further comprising providing a hotspot.

24. The method of claim 16, further comprising receiving, at a transmitter, content from the controller via a standard communications interface.

25. The method of claim 24, wherein the standard communications interface is HDMI.

26. The method of claim 16, further comprising transmitting, using a transmitter, different media content to different wireless receivers.

27. The method of claim 16, further comprising transmitting media content a second wireless receiver, wherein media content transmitted to the first wireless receiver is not necessarily substantially similar to media content transmitted to the second wireless receiver.

28. The method of claim 16, further comprising receiving live audio or video content.

29. The method of claim 16, further comprising receiving, at a transmitter, a wireless command from at least one of the one or more wireless receivers to control the operation of a media content distributing base station.
